(19) United States
(12) Patent Application Publication
(10) Pub. No.: US 2012/0305319 A1
(43) Pub. Date: Dec. 6, 2012

(54) SAFETY JOINT WITH INDICATING FEATURE

(75) Inventor: Jacob M. Zachry, Ventura, CA (US)

(73) Assignee: BAKER HUGHES INCORPORATED, Houston, TX (US)

(21) Appl. No.: 13/151,878

(22) Filed: Jun. 2, 2011

(51) Int. Cl. E21B 19/00; F16L 21/02; B23P 11/00; F16L 21/00; F16L 25/00; F16L 55/00; F16L 19/06

(52) U.S. Cl. 175/320; 285/93; 285/335; 285/343; 285/369; 285/31; 29/407.01

(57) ABSTRACT

A joint assembly, including a first member including an indicator; a second member operatively arranged to sealingly engage the first member via a seal element, the indicator operatively arranged to provide an indication when the first member has been engaged with the second member.

### BACKGROUND

In the completions and drilling industry, an intentionally weakened connection or safety joint is sometimes included between two members in a drillstring or the like. Safety joints enable, for example, a top portion of the string, above the joint, to be pulled out of the borehole, while leaving a bottom portion in the hole for later retrieval. In some situations, the joint is reengaged by running the top portion of the string back into the hole. In order for the string to enable the passage of hydrocarbons or the like therethrough, the reengaged joint must be fluidly sealed. Various methods have been employed to verify the sealed engagement of reengaged safety joints. However, these tests can be timely, costly, inaccurate, or have other disadvantages. Accordingly, the industry is constantly desirous of new arrangements that enable verification of sealed engagement of safety joint type connections.

### BRIEF DESCRIPTION

A joint assembly, including a first member including an indicator; a second member operatively arranged to sealingly engage the first member via a seal element, the indicator operatively arranged to provide an indication when the first member has been engaged with the second member.

A method of forming a joint, including providing a first member having an indicator thereon; providing a second member; providing a seal element between the first and second members; engaging the first member with the second member until the indicator provides an indication that the first and second members have been sealingly engaged via the seal element.

### BRIEF DESCRIPTION OF THE DRAWINGS

The following descriptions should not be considered limiting in any way. With reference to the accompanying drawings, like elements are numbered alike:

FIG. 1 is a quarter-sectional view of a joint assembly according to one embodiment described herein;

FIG. 2 is a quarter-sectional view of a retrievable sub of the joint assembly of FIG. 1;

FIG. 3 is a quarter-sectional view of an alternate embodiment of an indicator as described herein; and

FIG. 4 is a quarter-sectional view of another embodiment of an indicator as described herein.

### DETAILED DESCRIPTION

A detailed description of one or more embodiments of the disclosed apparatus and method are presented herein by way of exemplification and not limitation with reference to the Figures.

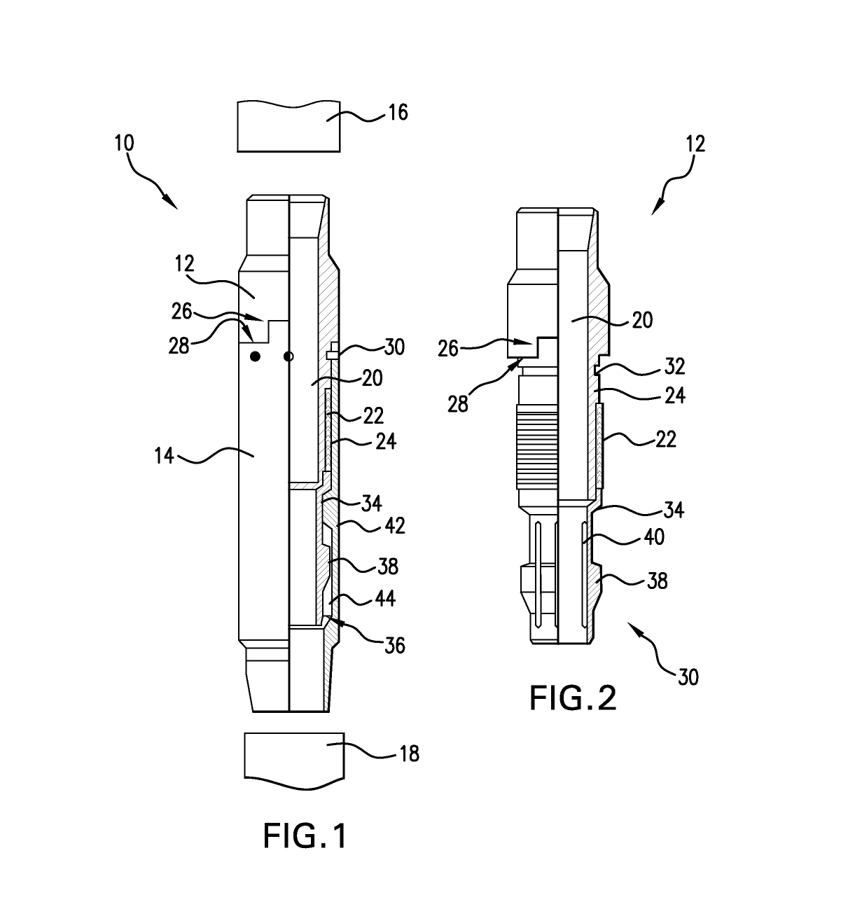

Referring now to FIG. 1, a joint assembly 10 is shown. The joint assembly 10 includes a retrievable sub 12 and a bottom sub 14. The assembly 10 is arranged, for example, to be installable as a safety joint between a first tubular 16 (or string of tubulars) and a second tubular 18 (or string of tubulars). The retrievable sub 12 and the bottom sub 14 are arranged to be sealed together in order to form a passageway 20 for passing fluids, gas, oil, hydrocarbons, etc. between the first and second tubulars 16 and 18. In the illustrated embodiment, a seal element 22 is provided on a body 24 of the retrievable sub 12 in order to seal the passageway 20. In one embodiment, the seal element 22 is formed as a v-packing seal. Advantageously, if the seal element 22 becomes damaged, the seal element 22 can be replaced or repaired by retrieving the retrievable sub 12 (discussed in more detail below).

The first and second tubulars 16 and 18 could be, for example, production tubing, portions of a drillstring, etc. In the illustrated embodiment, an anti-rotation feature 26 is included between the retrievable sub 12 and the bottom sub 14 in order to prevent relative rotation between the two subs 12 and 14. The anti-rotation feature in the illustrated embodiment is provided as a key, axially overlapping portions on the retrievable sub 12 and bottom sub 14, etc. The anti-rotation feature 26 could be used to transfer torque between the retrievable sub 12 and the bottom sub 14, for example, if the assembly 10 is installed as part of a drillstring. An interface 28 that is formed at the anti-rotation feature 26 is also provided as an axial stop for limiting the distance the retrievable sub 12 can be stabbed down into the bottom sub 14. The interface 28 is essentially radially overlapping portions of the retrievable sub 12 and the bottom sub 14 to limit relative axial movement between the subs 12 and 14.

During use of the assembly 10, the bottom sub 14 is arranged to be secured to the tubular 18 (located downhole of the joint assembly 10), while the retrievable sub 12 is arranged to be secured to the tubular 16 and detachable from the bottom sub 14 (and any other tubulars located further downhole, e.g., the tubular 18). In the illustrated embodiment, a plurality of shear screws 30 are shown extending through the bottom sub 14 and engaged in a groove 32 of the retrievable sub 12 in order to releasably secure the retrievable sub 12 to the bottom sub 14. However, it is to be understood that any other release member, releasable securing means, intentionally weakened section, etc., could be used to form a safety joint type connection between the retrievable sub 12 and bottom sub 14.

By releasably securing the retrievable sub 12 to the bottom sub 14, the retrievable sub 12, and any components above the retrievable sub 12, can be removed, while the bottom sub 14, and the other tubulars located further downhole, remain in the borehole. In this way, tools, packers, tubulars, etc., can be retrieved without pulling up the entire string, and certain components removed, repaired, or replaced before being reinstalled. For example, assembly 10 could be used in completions to connect multiple stages of gravel packs, frac packs, etc. For example, the joint assembly 10 could be positioned with gravel packing tools to performing a gravel packing operation. The retrievable sub 12 could then be used to disconnect the gravel packing tools from a gravel packed liner after pumping operations have been completed. In this example, the retrievable sub 12 and the gravel pack tools could be pulled out of the borehole by pulling up on the retrievable sub 12 until the screws 18 shear and the retrievable sub 12 is released from the bottom sub 14. Once out of the borehole, the gravel packing tools can then be removed from the string, and the retrievable sub 12 attached to the bottom of an isolation assembly or the like, and run back in to be reengaged with the bottom sub 14. In a further example, the retrievable sub 12 could be pulled out multiple times such that perforation guns or the like could also be run in, actuated to perforate a casing, liner, etc. in a zone located above the joint assembly 10, then pulled back out and removed, so that well operations can commence in a new zone after the retrievable sub 12 is again reengaged with the bottom sub 14. In this example utilizing perforation guns, it should be noted that the relative position of the joint assembly 10 is known, and this enables the depth of the perforation guns to be verified and set with better accuracy.

The joint assembly 10 is advantageously adapted for running in the retrievable sub 12 and engaging the retrievable sub 12 with the bottom sub 14 multiple times by inclusion of an indicator device. Specifically, the indicator device in the illustrated embodiment takes the form of a snap nut 34. The snap nut 34 is securable to the retrievable sub 12, for example by a threaded connection. Alternatively, the snap nut could be attached to the bottom sub 14 facing up toward the retrievable sub 12. The snap nut 34 includes a collet 36 (e.g., comprising a radial bulge 38 and a plurality of slots 40) so that the snap nut can radially compress and expand. Specifically with respect to the embodiment of FIGS. 1 and 2, by exerting a downward force on the retrievable sub 12, the bulge 38 will first radially compress due to interference with a radially inward projection 42 of the bottom sub 14, and then expand into cavity 44 of the bottom sub 14 as the retrievable sub 12 is stabbed deeper into the bottom sub 14. As described above, longitudinal engagement of the two subs 12 and 14 is limited by the interface 28.

Use of the snap nut 34 enables more accurate verification that the retrievable sub 12 has been properly stabbed into the bottom sub 14. A weight indicator or other measurement device can be used to reliably and positively detect when the retrievable sub 12 and the bottom sub 14 are re-engaged. For example, extra set-down force is necessary for the bulge 38 to compress and axially travel past the radially inward projection 42. The extra set-down force is observable as an increasing drop in tension in the string, as some of the weight of the string is supported by the bottom sub 14 and the downhole components at the inward projection 42. Once the collet 36 enters the cavity 44, the string is suddenly released and the tensile load correspondingly increases to reflect the sudden unsupported weight of the hanging string. After this sudden release is observed, it can be ensured with a relatively high degree of confidence that the two subs 12 and 14 are sealingly engaged, and not improperly snagged, blocked, restricted, etc., on each other or some other component. Furthermore, this reduces the need to perform additional or alternate tests to verify that the seal has been engaged, such as fluid circulation tests, which are more timely and can be inaccurate, especially if used when a gravel pack is utilized because fluid can be lost into the gravel and sandy deposits or the like in formation walls.

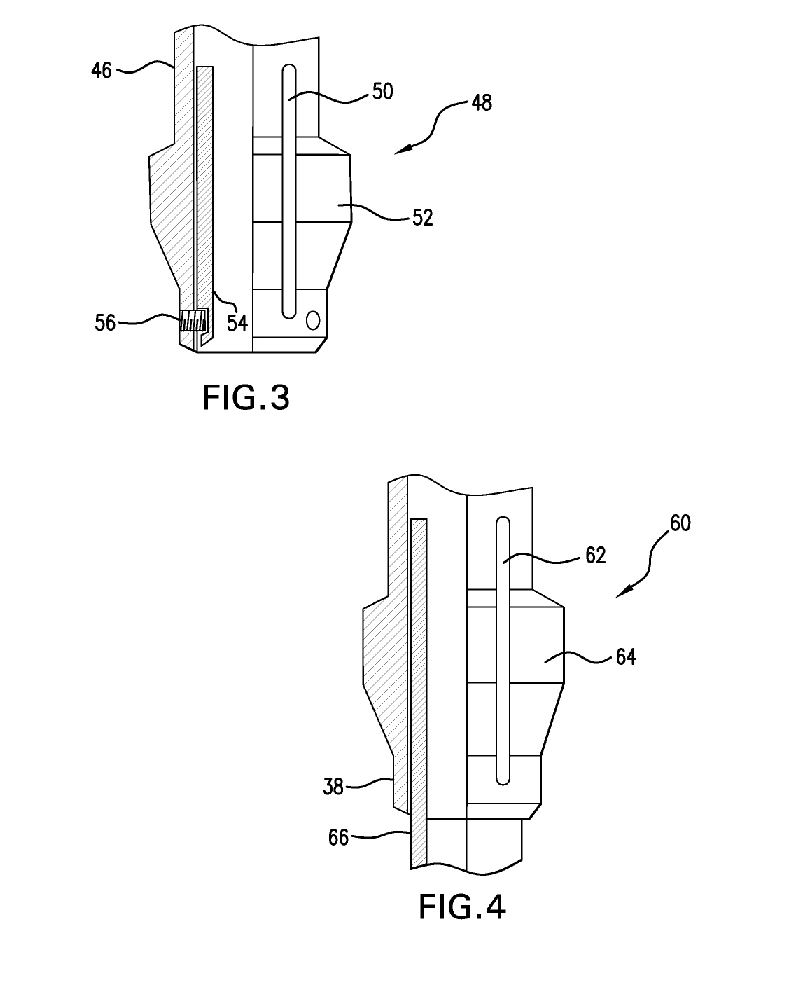

FIG. 3 shows a snap nut 46 that can be used with the retrievable sub 12 in lieu of the snap nut 34. The snap nut 46 resembles the snap nut 34 in many respects, including a collet 48 that comprises a plurality of slots 50 and a radial bulge 52 for the same reasons as discussed above with respect to the corresponding components on the snap nut 34. Unlike the snap nut 34, the snap nut 46 is releasably attached to a support sleeve 54 via shear screws 56. The support collar 54 is disposed radially within the snap nut 46 for preventing the collet 48 from compressing. In this way, the support sleeve 54 can prevent the snap nut 46 from becoming prematurely disengaged from a cavity of bottom tubular or sub, such as the cavity 44 of the bottom sub 14. The sleeve 54 may include a profiled axial surface or some other means, for engagement with a similarly profiled tool or member for shearing the screws 56 and shifting the sleeve 54 up or down in order to release the collet 48.

Because the sleeve 54 prevents compression of the collet 48, an assembly utilizing the snap nut 46 could be assembled, for example, by first installing the sleeve 54 to the snap nut 46 with the screws 56 and then inserting the sleeve 54 up through the bottom of a bottom member or sub, before attaching to a body of a top member or sub. The snap nut 46 may include exterior threads to secure to the top member or sub, unlike the interior threads shown in FIGS. 1 and 2 on the snap nut 34 in order to be fed up through the bottom of a bottom member. After the screws 56 have been sheared, the sleeve 54 can be discarded, used on another assembly, etc., and the snap nut 46 will operate essentially exactly as described above with respect to the snap nut 34.

A snap nut 58 is shown in FIG. 4, generally resembling both of the snap nuts 34 and 46, e.g., including a plurality of slots 62 and a radial bulge 64. Also similar to the snap nut 46, the snap nut 58 is arranged to have a support sleeve 66 disposed radially within the snap nut 58 for preventing the snap nut 46 from compressing once engaged in a cavity of a bottom member or sub, e.g., the cavity 44 of the bottom sub 14. Unlike the embodiment including the snap nut 46, the support sleeve 66 in FIG. 4 is not mechanically fastened to the snap nut 58 (e.g., there are no shear screws). Instead, the releasable member or means between the snap nut 58 and a bottom member or sub (e.g., the bottom sub 14) is the sleeve 66 itself. The sleeve 66 could be any other tubular disposed in a string, for example, a wash pipe. A wash pipe or other sleeve could be pulled out of the hole or shifted up or down first, thus releasing the collet 60 of the snap nut 58.

Advantageously, the currently described embodiments result in joint assemblies, such as the joint assembly 10, providing a detachable sealed passageway with a reliable and repeatable indication function, which enables, for example, multiple components to be run in or pulled out in various arrangements to more quickly and easily perform various tasks for preparing equipment in a borehole, such as operating a drillstring, installing a gravel pack, perforating a liner or casing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A joint assembly, comprising:
a first member including an indicator;
a second member operatively arranged to sealingly engage the first member via a seal element, the indicator operatively arranged to provide an indication when the first member has been engaged with the second member.

2. The joint assembly of claim 1, further comprising a releasable member for enabling disconnection of the first member from the second member.

3. The joint assembly of claim 2, wherein the releasable member comprises at least one shear screw.

4. The joint assembly of claim 1, wherein the first member includes the seal element.

5. The joint assembly of claim 1, wherein the seal element is a v-packing seal.

6. The joint assembly of claim 1, wherein the indicator includes a collet.

7. The joint assembly of claim 6, wherein the collet is operatively arranged to compress into a cavity in the second member bounded by an inner radial projection.

8. The joint assembly of claim 6, wherein a sleeve is radially disposed within the collet for preventing the collet from compressing until the sleeve is removed.

9. The joint assembly of claim 8, wherein the sleeve is mechanically secured to the collet via at least one releasable member.

10. The joint assembly of claim 8, wherein the sleeve is a wash pipe.

11. The joint assembly of claim 1, wherein the joint assembly is installed between a pair of tubulars.

12. The joint assembly of claim 11, wherein the joint assembly and the pair of tubulars are part of a drillstring.

13. The joint assembly of claim 11, wherein the second member is located downhole from the first member.

14. The joint assembly of claim 1, further comprising an anti-rotation feature for enabling torque to be transferred between the first and second members.

15. The joint assembly of claim 1, wherein the indication that the first member has engaged with the second member is observable as differences in weight.

16. The joint assembly of claim 1, wherein an interface formed from radially overlapping portions between the first member and the second member limits axial engagement of the first member with the second member.

17. A method of forming a joint, comprising:
providing a first member having an indicator thereon;
providing a second member;
providing a seal element between the first and second members;
engaging the first member with the second member until the indicator provides an indication that the first and second members have been sealingly engaged via the seal element.

18. The method of claim 17, further comprising a releasable member for enabling disconnection of the first member from the second member.

19. The method of claim 17, wherein the indicator includes a collet and the second member includes a cavity, the method further comprising engaging the collet in the cavity of the second member.

20. The method of claim 19 further comprising observing differences in weight as the collet enters the cavity.
